(19) United States
(12) Patent Application Publication
(10) Pub. No.: US 2013/0244094 A1
(43) Pub. Date: Sep. 19, 2013

(54) LITHIUM STORAGE BATTERY COMPRISING AN IONIC LIQUID ELECTROLYTE

(71) Applicants: Nelly Giroud, Saint Etienne (FR); Djamel Mourzagh, Saint Egreve (FR); Helene Rouault, Le Versoud (FR); Sebastien Solan, Seyssinet-Pariset (FR)

(72) Inventors: Nelly Giroud, Saint Etienne (FR); Djamel Mourzagh, Saint Egreve (FR); Helene Rouault, Le Versoud (FR); Sebastien Solan, Seyssinet-Pariset (FR)

(73) Assignee: COMMISSARIAT a l'ENERGIE ATOMIQUE ET AUX ENERGIES ALTERNATIVES, Paris (FR)

(21) Appl. No.: 13/882,882

(22) PCT Filed: Oct. 28, 2011
(86) PCT No.: PCT/FR11/00581

§ 371 Date: May 1, 2013

(30) Foreign Application Priority Data
Nov. 2, 2010 (FR) 1004293

(51) Int. Cl. H01M 2/02

(52) U.S. Cl. CPC H01M 2/02
USPC 429/185

(57) ABSTRACT

The invention relates to a lithium storage battery comprising at least one electrochemical cell arranged in a tightly sealed packaging. The electrochemical cell is formed by a stack comprising a separator arranged between first and second electrodes. The separator is impregnated by an ionic liquid electrolyte comprising a mixture of a lithium salt, vinyl ethylene carbonate and an ionic liquid of formula C+A− in which C+ represents a cation and A− represents an anion. The first electrode comprises an electrochemically active material and a polymer-based binder chosen from polyacrylic acid (PAA) and sulfonated perfluoropolymers.

### BACKGROUND OF THE INVENTION

The invention relates to a lithium storage battery comprising at least one electrochemical cell arranged in a tightly sealed packaging and formed by a stack comprising a separator arranged between first and second electrodes, said separator being impregnated by an ionic liquid electrolyte comprising a mixture of a lithium salt, vinyl ethylene carbonate and an ionic liquid of formula C⁺A⁻ in which C⁺ represents a cation and A⁻ represents an anion, and said first electrode comprising an electro-chemically active material and a polymer-based binder.

### STATE OF THE ART

As represented in FIG. 1, lithium storage batteries are conventionally formed by an electrochemical cell 1 or a stack of electrochemical cells 1 in a packaging 2. Each electrochemical cell 1 is formed by a positive electrode 3 and a negative electrode 4 separated by an electrolyte 5, a first current collector 6a connected to positive electrode 3 and a second current collector 6b connected to negative electrode 4. First and second current collectors, 6a and 6b, pass through packaging 2 and respectively form first and second poles, 7a and 7b, at their ends (on the right of FIG. 1), to perform transportation of electrons to an external electric circuit (not shown). Electrolyte 5 can be in solid, liquid or gel form.

Lithium storage batteries can also comprise a separator 8, impregnated by liquid or gel electrolyte 5, arranged between positive and negative electrodes 3 and 4. Separator 8 prevents any short-circuiting by preventing positive electrode 3 from coming into contact with negative electrode 4.

Positive electrode 3 comprises an electrochemically active material conventionally chosen from lithium cation (Li⁺) insertion materials.

Negative electrode 4 comprises an electrochemically active material in most cases chosen from metal lithium, graphite carbon and Lithium Li+ insertion materials.

When each of positive and negative electrodes, 3 and 4, is formed by a Lithium Li+ insertion material, the lithium storage battery is a Lithium-ion storage battery.

First current collector 6a connected to positive electrode 3 is conventionally made from aluminum and second current collector 6b connected to negative electrode 4 is in general made from copper, nickel-plated copper or aluminum.

Packaging 2 is flexible or rigid according to the targeted application. For a thin flexible Lithium-ion storage battery, packaging 2 is advantageously flexible.

The electrodes comprising a Lithium Li+ insertion material as electro-chemically active material are conventionally formed by ink coating, compression or calendering, followed by cutting into the form of electrode pads before being inserted into a lithium storage battery, typically a battery in button cell format.

The ink is conventionally formed from the Lithium Li+ insertion material, dispersed in an organic or aqueous solvent and then coated on the corresponding current collector 6a or 6b.

The coating step is conventionally followed by drying of the ink/collector assembly 6a or 6b to remove the solvent contained in the ink.

The coating thickness defines the grammage of the electrode. What is meant by grammage is the weight of Lithium Li+ insertion material per surface unit. The surface capacity of the electrode, expressed in mAh.cm⁻², can be calculated from the specific capacity of the Lithium Li+ insertion material forming positive electrode 3 or negative electrode 4 and from the grammage obtained.

The composition of the ink, in particular the percentage of active Lithium Li+ insertion material, changes according to the targeted application. A distinction can thus be made between the formulations of electrodes for a lithium storage battery called “power” battery and those for a lithium storage battery called “energy” battery.

A binder can also be added to the ink to ensure the mechanical strength of positive electrode 3 or negative electrode 4 and to improve the interface between electrode, 3 or 4, and separator 8.

The binders for a lithium storage battery electrode are numerous. However, the most common are polymers which can be classified in two categories; polymer binders soluble in organic solvents such as polyvinylidene fluoride (PVDF) and; polymer binders soluble in an aqueous solvent such as carboxymethyl cellulose, abbreviated to CMC, nitrile butadiene rubber, styrene butadiene rubber, abbreviated to SBR, and polyacrylic acid, abbreviated to PAA.

Recently, the applicant proposed in the document FR-A-2935547 an improved ionic liquid electrolyte suitable for use in a lithium storage battery. The ionic liquid electrolyte comprises an ionic liquid of C⁺A⁻ formula where C⁺ represents a cation and A⁻ an anion, a conducting salt and Vinyl Ethylene Carbonate, abbreviated to VEC. In particular, comparative cycling tests were performed using an electrochemical cell of button cell format fitted in a sealed stainless steel enclosure. The results showed better performances of the storage battery according to the invention than those of conventional storage batteries with an organic electrolyte. It was further shown that the ionic liquid electrolyte presents a thermal stability which is able to reach a figure of 450° C.

### OBJECT OF THE INVENTION

The object of the invention is to provide a lithium storage battery containing an ionic liquid electrolyte having improved electrochemical performances, in particular at high temperature.

It is a further object of the invention to provide improvements to the lithium storage battery disclosed by the applicant in the document FR-A-2935547, in particular as far as the mechanical strength and reliability at high temperature are concerned.

A final object of the invention is to provide a lithium storage battery that is economically viable, easy to implement and of small dimensions.

According to the invention, this object is achieved by a lithium storage battery comprising at least one electrochemical cell arranged in a tightly sealed packaging and formed by a stack comprising a separator arranged between first and second electrodes, said first electrode comprising an electrochemically active material and a polymer-based binder, the polymer being chosen from polyacrylic acid (PAA) and sulfonated perfluoropolymers.

According to the invention, this object is further achieved by the fact that the separator is impregnated by an ionic liquid electrolyte comprising a mixture of a lithium salt, vinyl ethylene carbonate (VEC) and an ionic liquid of C⁺A⁻ formula in which C⁺ represents a cation and A⁻ represents an anion.

According to the invention, this object is achieved by the fact that the polymer is chosen from polyacrylic acid (PAA) and sulfonated perfluoropolymers.

According to the invention, this object is also achieved by the fact that the packaging comprises a material chosen from polyethylenimines, abbreviated to PEI, and polyethylarylketones, abbreviated to PAEK.

According to a preferred embodiment, the binder is formed by polyacrylic acid (PAA).

According to another preferred embodiment, the polyacrylic acid (PAA) has a mean molecular weight that is greater than or equal to 1,100,000 g.mol ⁻¹, preferably greater than or equal to 1,250,000 g.mol⁻¹ and strictly less than 3,000,000 g.mol⁻¹, and the percentage of electrochemically active material with respect to the total weight of the first electrode is greater than or equal to 90% by weight and less than 100%.

According to a development of the invention, the packaging is formed by at least one sheet of polyaryletherketone, abbreviated to PAEK, preferably made from polyethyletherketone, abbreviated to PEEK.

### BRIEF DESCRIPTION OF THE DRAWINGS

Other advantages and features will become more clearly apparent from the following description of particular embodiments of the invention given for non-restrictive example purposes only and represented in the appended drawings, in which:

FIG. 1 schematically represents a cross-section of a lithium storage battery according to the prior art.

FIG. 2 represents a curve plot of a cycling test, performed at a temperature of 150° C., of a half-cell corresponding to a lithium storage battery (metal Li negative electrode)/(separator made from glass fibres impregnated with an ionic liquid electrolyte)/(LiFePO₄ positive electrode with PAA binder) according to a particular embodiment of the invention.

### DESCRIPTION OF PARTICULAR EMBODIMENTS

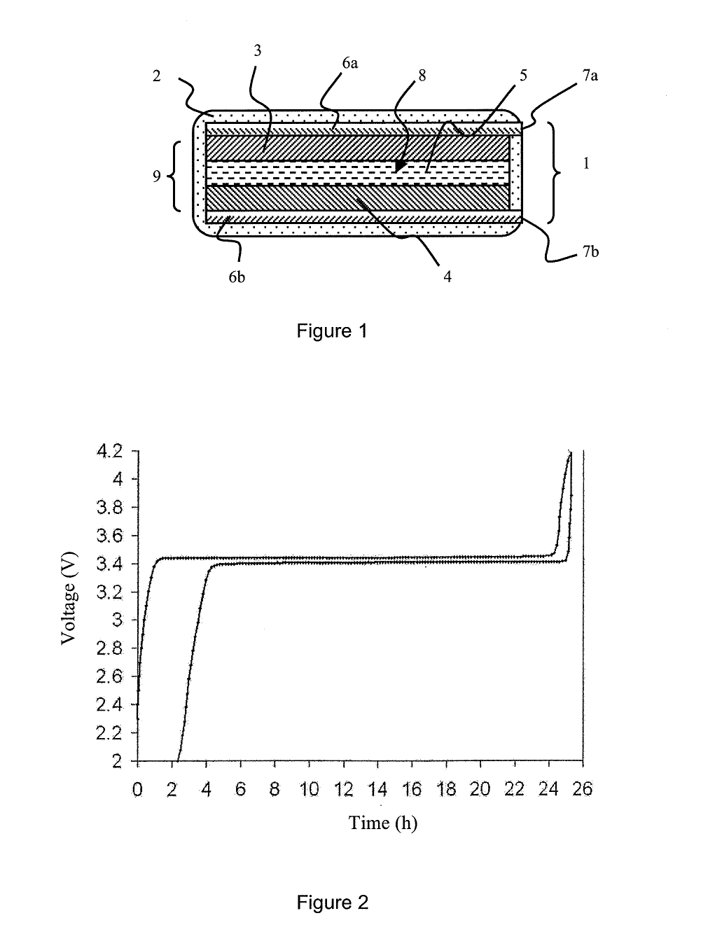

FIG. 1 relates to a lithium storage battery according to the state of the art: a commentary of the latter has been given in the preamble and will therefore not be described in further detail in the following. For the sake of clarity, the same elements of the state of the art and according to the invention are designated by the same reference numerals.

According to a particular embodiment, a lithium storage battery comprises at least one electrochemical cell 1 arranged in a tightly sealed packaging 2.

Electrochemical cell 1 is formed by a stack 9 comprising a separator 8 arranged between first and second electrodes 3 and 4. First electrode 3 can be a positive electrode and second electrode 4 can be a negative electrode.

A first current collector 6a and a second current collector 6b are arranged on each side of stack 9 and are respectively connected to first and second electrodes 3 and 4.

Separator 8 can be a porous membrane which is preferably glass fibre-based. Separator 8 can be formed by non-woven glass fibres sunk in a polymer to improve their very low mechanical stability. Separator 8 is impregnated by an ionic liquid electrolyte 5.

Ionic liquid electrolyte 5 comprises a mixture of an ionic liquid, at least one lithium salt and vinyl ethylene carbonate (VEC).

What is meant by ionic liquid electrolyte is an electrolyte constituted for the most part by ionic liquid, i.e. comprising at least 50% of ionic liquid, advantageously at least 80% of ionic liquid, and preferably about 90% of ionic liquid.

Ionic liquids can be defined as liquid salts comprising a cation and an anion. Ionic liquids are thus generally composed of a voluminous organic cation giving them a positive charge, with which an inorganic anion giving them a negative charge is associated. The ionic liquid acts as solvent.

The ionic liquid complies with the formula C⁺A⁻ in which C⁺ represents a cation and A⁻ represents an anion.

The C⁺ cation of the ionic liquid is advantageously chosen from organic cations, preferably from N, N-propyl-methyl-piperidinium bis (trifluoromethane sulfonyl) imide (PP13TFSI); 1-hexyl-3-methylimidazolium bis (trifluoromethane sulfonyl) imide (HMITFSI); (1,2-dimethyl-3-n-butylimidazolium) bis (trifluoromethane sulfonyl) imide (DMBIFSI), (1-nbutyl-3-methylimidazolium) bis (trifluoromethane sulfonyl) imide (BMITFSI) and mixtures thereof.

The A⁻ anion of the ionic liquid can be chosen from halogenides, preferably from BF₄⁻, TFSI(N(SO₂CF₃)²⁻) and TFSi⁻.

The lithium salt enables displacement of the lithium cation from first electrode 3 to second electrode 4, and vice-versa.

The lithium salt is advantageously lithium hexafluorophosphate (LiPF₆), lithium tetrafluoroborate (LiBF₄), bis (fluorosulfonyl) lithium imide (LiFSI) and bis (trifluoromethylsulfonyl) lithium imide (LiTFSI) and mixtures of the latter.

Vinyl ethylene carbonate, abbreviated to VEC, is used as specific additive. VEC in particular enables a passivation layer to be obtained on a graphite negative electrode 4 as described in the document FR-A-2935547 the content of which is totally incorporated by reference in the present application or which will be able to act as reference for the person skilled in the art.

Ionic liquid electrolyte 5 advantageously comprises from 0.1 mol/L to 10 mol/L of lithium salt, preferably between 1 mol/L and 2 mol/L of lithium salt.

Ionic liquid electrolyte 5 advantageously comprises from 1% to 10%, preferably from 2% to 5% by volume, of VEC with respect to the volume of ionic liquid.

As a first example, ionic liquid electrolyte 5 comprises

1.6 mol/L of LiTFSI in the ionic liquid solvent PP13TFSI and from 1% to 10% by volume of VEC, preferably 5%.

As a second example, ionic liquid electrolyte 5 comprises

1.6 mol/L of LiTFSI in the ionic liquid solvent HMITFSI and from 1% to 10% by volume of VEC, preferably 5%.

As a third example, ionic liquid electrolyte 5 comprises 1.6 mol/L of LiTFSI in the ionic liquid solvent DMBITFSI and from 1% to 10% by volume of VEC, preferably 5%.

As a fourth example, ionic liquid electrolyte 5 comprises 1.6 mol/L of LiTFSI in the ionic liquid solvent BMITFSI/BF₄⁻ and from 1% to 10% by volume of VEC, preferably 5%.

First electrode 3 comprises an electrochemically active material and a polymer-based binder.

The electrochemically active material is advantageously a Lithium Li+ insertion material. The Lithium Li+ insertion material can be chosen from non-lithiated materials such as for example copper sulfides or disulfides (Cu or CuS₂), tungsten oxysulfides (WO_{y}S_{z}), titanium disulfides (TiS₂), titanium oxysulfides (TiOₓS_{y}) or vanadium oxides (VₓO_{y}), lithiated materials such as for example lithium-based mixed oxides such as lithium and cobalt oxide (LiCoO₂), lithium and nickel oxide (LiNiO₂), lithium and manganese oxide (LiMn₂O₄), lithium and vanadium pentoxide (LiV₂O₅), lithium and iron phosphate (LiFePO₄) or lithium, manganese and nickel oxide (LiNi_{0.5}Mn_{1.5}O₄).

The electrochemically active material is preferably LiFePO₄.

The binder is polymer-based chosen from polyacrylic acid (PAA) and sulfonated perfluoropolymers. The binder thus comprises a polymer chosen from polyacrylic acid (PAA) and sulfonated perfluoropolymers.

The term “-based” should be interpreted in the sense of “comprising a majority of”, i.e. the binder comprises more than 50% of the polymer, advantageously between 90% and 100% by weight of polymer. The binder is preferably constituted by the polymer.

When formulation of the ink is performed, the polymer is generally dissolved in a solvent, such as water, to attain a viscosity propitious to shaping of the electrode, the fabrication conditions of which are within the scope of the person skilled in the art.

Among known sulfonated perfluoropolymers, perfluorosulfonate ionomers of NAFION® type (Dupont De Nemours registered trademark) will preferably be chosen.

According to a preferred embodiment, the polymer is formed by polyacrylic acid (PAA). An electrode comprising such a PAA binder has already been described in a French patent application filed on 29 Jul. 2010 by the applicant under application number FR-A-1003193. The content of this application FR-A-1003193 is incorporated by reference in the present application or will be able to act as reference for the person skilled in the art.

In particular, the polyacrylic acid (PAA) preferably has a mean molecular weight that is greater than or equal to 1,100,000 g.mol⁻¹, preferably greater than or equal to 1,250,000 g.mol⁻¹ and strictly less than 3,000,000 g.mol⁻¹.

The mean molecular weight of polyacrylic acid (PAA) is advantageously comprised between 1,250,000 g.mol⁻¹ and 2,000,000 g.mol⁻¹.

More particularly, the mean molecular weight of polyacrylic acid (PAA) is preferably equal to 1,250,000 g.mol⁻¹.

The percentage of electrochemically active material with respect to the total weight of first electrode 3 is advantageously greater than or equal or to 90% in weight and less than 100% in weight.

First electrode 3 preferably comprises more than 90% by weight of the electrochemically active material and 4% by weight of polyacrylic acid (PAA) or less than 4% by weight of polyacrylic acid (PAA), said percentages being calculated with respect to the total weight of the electrode.

In particular, first electrode 3 comprises more than 94% by weight of the electrochemically active material and less than 3% by weight of polyacrylic acid (PAA), said percentages being calculated with respect to the total weight of the electrode.

First electrode 3 can further comprise less than 3% of an electronic conductor. The electronic conductor is conventionally added to the Lithium Li+ insertion material to improve the electronic conductivity of electrode 3.

The electronic conductor can for example be chosen from carbon black, carbon fibres and a mixture of the latter.

The electrochemically active material can for example be constituted by particles of electrochemically active material coated with an electrically conducting material, in particular carbon obtained by means of any known method.

Second electrode 4 is advantageously formed by a material chosen from lithium and carbon. Second electrode 4 is in particular formed by metallic lithium or a carbon felt.

Packaging 2 can be flexible or rigid. Packaging 2 enables electro-chemical cell 1 to be contained and ensures the tightness of the lithium storage battery. A part of current collectors 6a and 6b respectively forming first and second poles 7a and 7b, which extend in the plane of electrochemical cell 1, passes through packaging 2.

Packaging 2 can be made from a metal of titanium, aluminum or stainless steel type. A packaging 2 made from polyethylenimines (PEI) and/or from polyethylarylketones (PAEKs), i.e. a packaging which comprises a material chosen from PEI and PAEKs, will nevertheless be preferred.

Packaging 2 can in particular be formed exclusively from polymer of PAEK type.

Packaging 2 can advantageously be formed by at least one sheet of polyethylarylketone (PAEK). Such a sheet of PAEK for a lithium storage battery packaging has already been described by the applicant in French patent application filed on Feb. 02, 2010 under application number FR-A-1050726. The content of this application FR-A-1050726 is incorporated by reference in the present application or can act as reference for the person skilled in the art.

The family of PAEK polymers which are suitable within the scope of the invention comprises the following polymers:
polyether ketone (PEK),
polyether ether ketone (PEEK™)
polyether ketone ketone (PEKK),
polyether ether ketone ketone (PEEKK),
polyether ketone ether ketone ketone (PEKEKK).

Packaging 2 can be constituted by a single sheet of PAEK folded onto itself in two parts secured to one another on their periphery.

Alternatively, packaging 2 can be constituted by a plurality of sheets of PAEK secured to one another on their periphery.

The two parts of a sheet of PAEK folded onto itself or two independent sheets of PAEK can be secured to one another by any known method, in particular by self-bonding, soldering, ultrasound, laser or by heat sealing.

According to a particular embodiment that is not represented, packaging 2 comprises at least one sheet of PAEK integrating in its thickness at least one metal stud forming one of the poles, 7a or 7b, of the lithium storage battery. Unlike the particular embodiment described above, first and second collectors, 6a or 6b, do not pass through packaging 2. The metal stud is soldered to the part of a current collector, 6a or 6b, contained inside packaging 2.

For example purposes, a metal stud made from aluminum soldered to the inner part of first current collector 6a made from aluminum can form first pole 7a. A metal stud made from copper soldered to the inner part of second current collector 6b made from copper can form second pole 7b.

According to an alternative embodiment that is not represented, packaging 2 is formed by a single sheet of PAEK integrating in its thickness two metal studs forming the first and second poles, 7a and 7b, of the lithium storage battery. The sheet of PAEK is folded onto itself in two parts secured to one another on their periphery, each of the two studs being soldered to the part of a current collector 6a or 6b contained inside packaging 2.

According to another alternative embodiment that is not represented, packaging 2 is formed by a single sheet of PAEK integrating in its thickness two metal studs constituting first and second poles, 7a and 7b, of the lithium storage battery and by a sheet of PAEK devoid of metal studs and secured at its periphery to the sheet of PAEK integrating the two metal studs. Each of the two studs is soldered to the part of a current collector 6a or 6b contained inside packaging 2.

According to another alternative embodiment that is not represented, packaging 2 is formed by two sheets of PAEK each integrating in its thickness a metal stud forming one of first and second poles, 7a and 7b, of the lithium storage battery. Each stud is soldered to the part of a current collector 6a or 6b contained inside packaging 2.

According to a preferred embodiment, the polyaryl ether ketone is advantageously polyether ether ketone (PEEK™).

A single flexible sheet of PEEK™ can be sufficient to form packaging 2 of the lithium storage battery. The sheets of PEEK™ marketed at the present time with a unitary thickness of 12 μm, 30 μm, 70 μm are suitable within the scope of the invention. Securing of several sheets of these ranges of thickness to one another can be performed in order to increase the strength of packaging 2.

When packaging 2 is formed by two sheets of PAEK, their unitary thickness can advantageously be chosen in such a way for them to be rigid, one of the sheets being machined to form a bottom of packaging 2 to contain electrochemical cell 1, and the other of the sheets integrating the metal studs constituting the cover of packaging 2.

Packaging 2 is advantageously produced by means of an identical method to the one described in said application FR-A-10580726 filed by the applicant.

The electrochemical performances of a lithium storage battery according to the invention were measured in a half-cell made from metallic lithium.

The half-cell is assembled with a first electrode 3 made from LiFePO₄/PAA, a separator 8 made from glass fibres impregnated by electrolyte 5 and a second electrode 4 made from metallic lithium.

The PAA used has a molecular weight of 1,250,000 g.mol⁻¹ and the ratio of the percentages by weight % LiFePO₄/% PAA is 90/10.

Glass fibre separator 8 is marketed by the Bernard Dumas Corporation under the reference AW1F1755.

Electrolyte 5 was produced according to the second example described in the foregoing. Electrolyte 5 is formed by a mixture of 5% by volume of VEC with 95% by volume of an ionic liquid formed by a solution of LiTFSI salt in HMITFSI at a concentration of 1.6 mol/L.

The half-cell formed in this way is then subjected to cycling testing at a C/20 charging rate at a temperature of 150° C.

As represented in FIG. 2, after five cycles, the restored capacity amounts to 159.6 mAh.g⁻¹.

The adhesion properties of first electrode 3 on first current collector 6a are improved. Furthermore, unlike the prior art, no lift-off or swelling or explosion phenomenon occurs at high temperature. No impairment of the electrochemical performances of the lithium storage battery is observed at high temperature.

The applicant thus surprisingly observed that the addition of polyacrylic acid (PAA) or of a sulfonated perfluoropolymer notably improves the electrochemical performances and the thermal resistance of the lithium storage battery.

In particular, compared with the prior art, the use of PAA as binder of the electrochemically active material of the first electrode, more particularly in the proportions and the range of molecular weights described above, gives the first electrode improved mechanical properties, a better adherence to first current collector 6a and a remarkable heat resistance without affecting the electrochemical performances of the first electrode.

Furthermore, the choice of the mean molecular weight of the PAA of the electrode has an appreciable effect on the thermal resistance and mechanical strength at high temperature of first electrode 3.

The lithium storage battery according to the invention is remarkable in that it presents an improved resistance at high, temperature and prevents any leakage and risk of explosion at high temperature. The lithium storage batteries according to the invention are moreover simple to implement, of small dimensions and inexpensive. Power or energy lithium storage batteries can easily be produced, within the scope of the invention, for a wide range of applications.

1-12. (canceled)

13. A lithium storage battery comprising at least one electrochemical cell arranged in a tightly sealed packaging and formed by a stack comprising a separator arranged between first and second electrodes, said separator being impregnated by an ionic liquid electrolyte comprising a mixture of a lithium salt, vinyl ethylene carbonate and an ionic liquid of formula C⁺A⁻ wherein C⁺ represents a cation and A⁻ represents an anion, and said first electrode comprising an electro-chemically active material and a polymer-based binder, wherein the polymer is polyacrylic acid, the mean molecular weight of polyacrylic acid being comprised between 1,250,000 g.mol⁻¹ and 2,000,000 g.mol⁻¹.

14. The storage battery according to claim 13, wherein the percentage of electrochemically active material with respect to the total weight of the first electrode is greater than or equal to 90% by weight and less than 100%.

15. The storage battery according to claim 13, wherein the mean molecular weight of polyacrylic acid is equal to 1,250,000 g.mol⁻¹.

16. The storage battery according to claim 13, wherein the electrochemically active material is a Lithium Li+ insertion material.

17. The storage battery according to claim 13, wherein the first electrode comprises more than 90% by weight of the electrochemically active material and 4% by weight of polyacrylic acid or less than 4% by weight of polyacrylic acid, said percentages being calculated with respect to the total weight of the electrode.

18. The storage battery according to claim 17, wherein the first electrode comprises more than 94% by weight of the electro-chemically active material and less than 3% by weight of polyacrylic acid, said percentages being calculated with respect to the total weight of the electrode.

19. The storage battery according to claim 17, wherein the first electrode comprises less than 3% of an electronic conductor.

20. The storage battery according to claim 13, wherein the separator is a glass fibre-based porous membrane.

21. The storage battery according to claim 13, wherein the second electrode is formed by a material chosen from lithium and carbon.

22. The storage battery according to claim 13, wherein the packaging comprises a material chosen from polyethylenimines and polyaryletherketones.

23. The storage battery according to claim 22, wherein the packaging is formed by at least one sheet of polyaryletherketone.

24. The storage battery according to claim 23, wherein the polyaryletherketone is polyetheretherketone.
